(19) United States
(12) Patent Application Publication
(10) Pub. No.: US 2013/0061784 A1
(43) Pub. Date: Mar. 14, 2013

(54) Pallet Support

(71) Applicant: Green Line Armor, LLC, Quincy, IL (US)

(72) Inventor: Robert Kessler, Augusta, IL (US)

(73) Assignee: Green Line Armor, LLC, Quincy, IL (US)

(21) Appl. No.: 13/655,205

(22) Filed: Oct. 18, 2012

Related U.S. Application Data
(63) Continuation of application No. 12/137,689, filed on Jun. 12, 2008.

(51) Int. Cl. B65D 19/38; B23P 11/00; B65D 19/18

(52) U.S. Cl. CPC B65D 19/38; B65D 19/18; B23P 11/00
USPC 108/57.25; 108/51.11; 29/428

(57) ABSTRACT

When a pallet is in use, goods to be shipped are generally mounted on the top surface. A pallet support formed from a polymer, preferable a fiber reinforced biopolymer, fits on the open end of the pallet, and adds great strength thereto, while still permitting a loaded pallet to be used in a standard fashion.

### CROSS REFERENCE TO RELATED APPLICATION(S)

This Application claims the benefit of and priority to U.S. Utility patent application Ser. No. 12/137,689, filed Jun. 12, 2008, the entire disclosure of which is incorporated herein by reference.

### BACKGROUND OF THE INVENTION

1. Field of the Invention

This invention relates to a pallet support and more particularly to a pallet support, which slides onto the pallet and increases the useful life of the pallet.

2. Description of Related Art

Shipping, for a wide variety of goods, is commonly done on a pallet. The pallet has a top and a bottom surface separated by a spacing mechanism. The bottom surface is generally in contact with the ground or another surface when the pallet is in use. When the pallet is not in use, a series of pallets may be stacked for storage or transportation.

When the pallet is in use, goods to be shipped are generally mounted on the top surface. The spacing mechanism provides for the pallet and whatever is situated thereon to be lifted by a forklift or a similar device and transported to a desired position. This desired position may have a storage or a transport function.

Clearly, the pallet is placed under severe physical stress in use. Thus, it is very desirable to reduce that physical stress in an inexpensive and efficient manner. To that end, various structures are known. However, the structures tend to be expensive and inefficient.

In an effort to provide for an efficient use of resources, many pallet modifications are known. Typically, some sort of pallet support is placed over the end to protect the lifting side of the pallet, while at the same time, providing access thereto. With the pallet support in place, the pallet can last longer. With such efficiency, resources are used effectively.

However, a critical part of the effective use of resources includes a careful consideration of the pallet support. The materials used to make the pallet must be environmentally advantageous. The method of making the pallet must be efficient. The energy consumed thereby must be less than the energy used in the overall process of setting up the pallet.

Furthermore, if a plastic or synthetic resin material is used to make or reinforce the pallet, the overall environmental advantage can be compromised due to the petroleum base required therefor. Accordingly, rendering a pallet more durable becomes a very complicated matter.

Clearly, these features can work against each other. Accordingly, great effort is required to determine which of the features can have which effect on the entire process. Each step of the process must be analyzed for the purpose of maximizing the efficiency of the entire situation.

### SUMMARY OF THE INVENTION

Among the many objectives of the present invention is the provision of a pallet support, which reinforces the pallet.

Another objective of the present invention is the provision of a pallet support, which increases the useful life of the pallet.

Yet another objective of the present invention is the provision of a pallet support, which reduces the use of petrochemicals.

Still, another objective of the present invention is the provision of a pallet support, which efficiently uses resources in manufacturing the pallet support.

These and other objectives of the invention (which other objectives become clear by consideration of the specification, claims and drawings as a whole) are met by providing a pallet support, formed from a composite material or polymer; especially a fiber reinforced, biopolymer.

### BRIEF DESCRIPTION OF DRAWINGS

FIG. 1 depicts an exploded perspective view of the four runner pallet support 100 of this invention on pallet 102.

FIG. 2 depicts a top plan of the four runner pallet support 100 of this invention on pallet 102 based on FIG. 1.

FIG. 3 depicts a top perspective view of the four runner pallet support 100 of this invention.

FIG. 4 depicts a rear perspective view of the four runner pallet support 100 of this invention.

FIG. 5 depicts a bottom, plan view of the four runner pallet support 100 of this invention.

FIG. 6 depicts a top plan view of the four runner pallet support 100 of this invention.

FIG. 7 depicts a cross section view of the three runner pallet support 100 of this invention.

FIG. 8 depicts a front plan view of the three runner pallet support 200 of this invention in cross-section.

FIG. 9 depicts a cross section view of the three runner pallet support 200 of this invention along Line 9-9 in FIG. 8.

FIG. 10 depicts an interior, close-up, plan view of honeycomb 170 of the pallet support 100 of this invention.

FIG. 11 depicts an interior plan view of the center portion of pallet support 100 of this invention.

FIG. 12 depicts the pallet support 100 of this invention on a pallet 102 in a block diagram form.

Throughout the figures of the drawings, where the same part appears in more than one figure of the drawings, the same number is applied thereto.

### DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar to directional terms are not to be construed to limit the scope of the invention in any manner. The words attach, connect, couple, and similar terms with their inflectional morphemes do not necessarily denote direct or intermediate connections, but may also include connections through mediate elements or devices.

The pallet support of this invention is formed of a composite material, which is durable and designed for use with a forklift or other uses. As a composite material, use of petroleum based resins can be minimized, and recycled materials or polymers can be used to form the pallet support. Compression molding of the composite material can form the pallet support into a desired shape for the strength to be used with a pallet and extend the life thereof.

Composite materials are created by combining two or more materials to produce a new material that retains important properties from the original components, and may even provide a stronger material. These unique combinations deliver significant advantages over traditional materials in a wide variety of structural applications. Composites consist of a resin, a polymer, a matrix material or combinations thereof, that is then reinforced with fibers that can be taken from ceramics, metals, or polymers. The reinforcing fibers are the primary load carriers of the material, with the matrix component or polymer of pallet support transferring the load thereon from fiber to fiber.

In a preferred form, this pallet support encapsulates an exposed portion of the two inches by four inches (two by four ends) wood stringers of the pallet, and replaces the top and bottom board on each end of the pallet. Removal of the end boards, creates that exposed portion to receive the pallet support.

If the pallet has no top end board and no bottom end board on each end of the support boards or stringers of the pallets, such removal is not required to use the pallet support. For conversion of a standard pallet to use the pallet support, such removal is highly preferred, if not required.

The pallet support may fit over the pallet without the removal of the top end board and the bottom end board, that is with the top end board and the bottom end board still in place. This requires slot modification and weakening of the pallet support which is not desired.

In a standard drop test, there is no damage from a corner drop or dropping pallet with the pallet support in place on a corner thereof. Such encapsulation minimizes the common industry pallet failure known as out of square damage, that is changing of the ninety degree angles at each corner of the pallet. This feature is important because over ninety (90%) percent of pallet damage comes from the “out of square”, and destruction of the lead boards and two by four ends.

The encapsulation of the pallet by the pallet support also minimizes breakage of the pallet itself. This bio-composite polypropylene blend is so strong or super tough, that it is actually used for auto bumpers and running boards. Rackability is extremely important and a great benefit in the pallet industry. This pallet provides rack ability and retains full rack strength because it utilizes the full length wood two by four present in the pallet. Full plastic pallets do not have near the same rack able strength as wooden pallets. So this pallet support provides the best of both worlds.

Reinforcement of the matrix material can be achieved in a variety of ways including particles. Fibers may be continuous or discontinuous with the matrix material, which is usually obtained from one of the many available engineering polymers.

Manufacturers' composites offer a flexible solution with the advantage of being able to select just the right combination of fiber reinforcement and resin material to meet both the application and property requirements of a finished part.

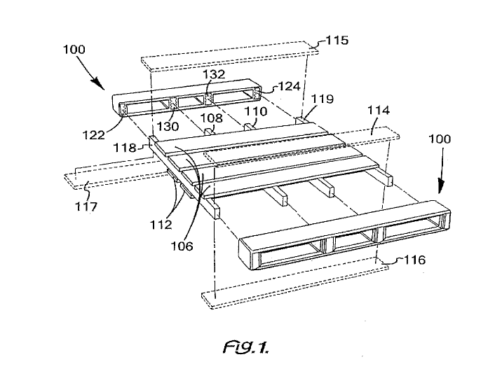

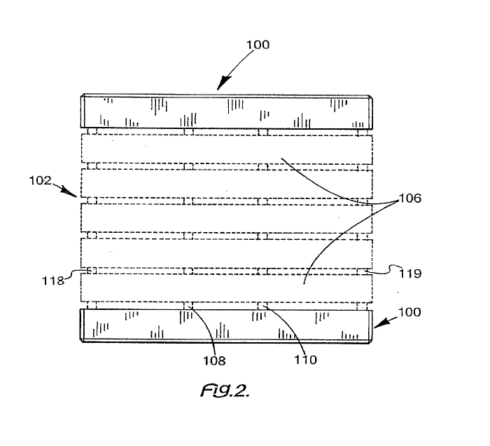

Referring now to FIG. 1, FIG. 2 and FIG. 5, the structure of the pallet support 100 with pallet 102 thereon is shown. With end top board 114 and end bottom board 116 and back end top board 115 and back end bottom board 117—removed from top platform 106 and bottom platform 112 respectively, four runner pallet support 100 fits over first center board 108 and the optional second center board 110 as well as with the first support board 118 and second support board on either side thereof. First center board 108 and the optional second center board 110 as well as with the first support board 118 and second support board 119 are usually two inches by four inches common in the lumber industry.

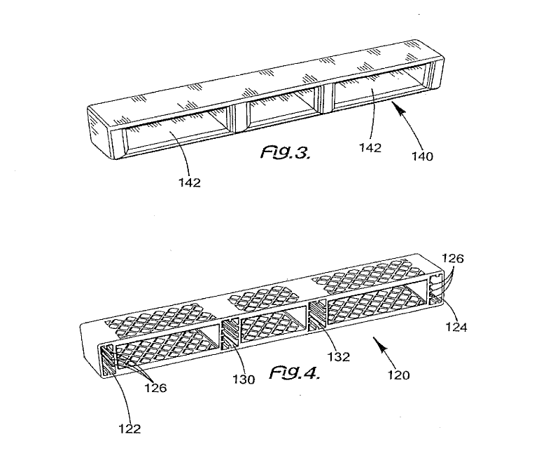

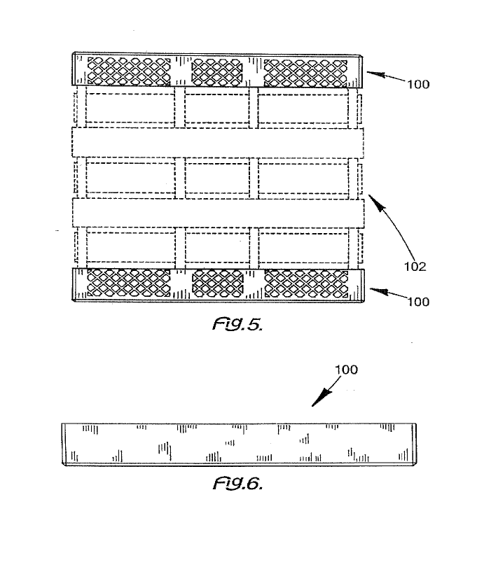

Adding FIG. 3, FIG. 4, FIG. 5 and FIG. 6, the structure of the four runner pallet support 100 for pallet 102 is shown. Four runner pallet support 100 has an open side 120 to receive a pallet 102, and a closed side 140 to limit the insertion of pallet 102. Within open side 120 are a first closed end slot 122 with a second closed end slot 124 oppositely disposed therefrom. With four runner pallet support 100 in place on pallet 102, each of first closed end slot 122 and second closed end slot 124 receives first support board 118 and second support board 119 respectively.

From open side 120, both first closed end slot 122 and second closed end slot 124 include end gripping ribs 126, preferably on three sides thereof. The gripping ribs 126 contact first support board 118 and second support board 119 of the pallet 102 in order to support four runner pallet support 100 on pallet 102.

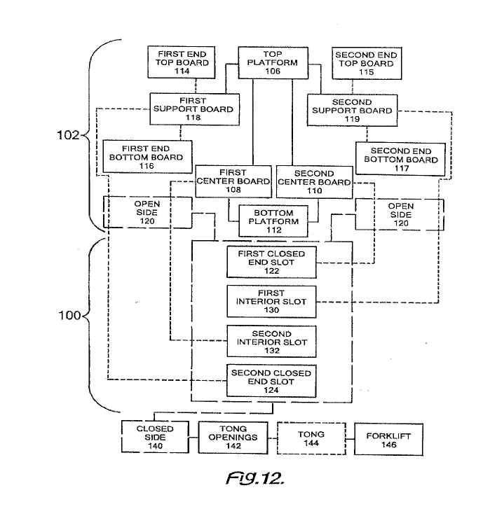

In a like manner from open side 120, between first closed end slot 122 and second closed end slot 124, first interior slot 130 and optional interior slot 132 provide a grip on first center board 108 and optional second center board 110, when four runner pallet support 100 is secured to pallet 102. Interior ribs 136 are present in first interior slot 130 and optional second interior slot 132 to serve the same function as end gripping ribs 126. First interior slot 130 and optional interior slot 132 have interior ribs 136 (FIG. 11), which grip first center board 108 and optional second center board 110.

Closed side 140 has tong openings 142 to receive the tongs 144 of the forklift 146 (FIG. 12). However, first closed end slot 122, second closed end slot 124, first interior slot 130, optional second interior slot 132, end gripping ribs 126, and interior ribs 136 are preferably closed on closed side 140. This facilitates mounting of the four runner pallet support 100 on pallet 102.

To facilitate the application of four runner pallet support 100 to pallet 102, end top board 114 and end bottom board 116 are removed from pallet 102 (FIG. 1). Pallet support 100 then receives first support board 118, second support board 119, first center board 108, and second center board 110 of pallet 102 more efficiently. In this manner, pallet support 100 being applied to pallet 102 is greatly facilitated.

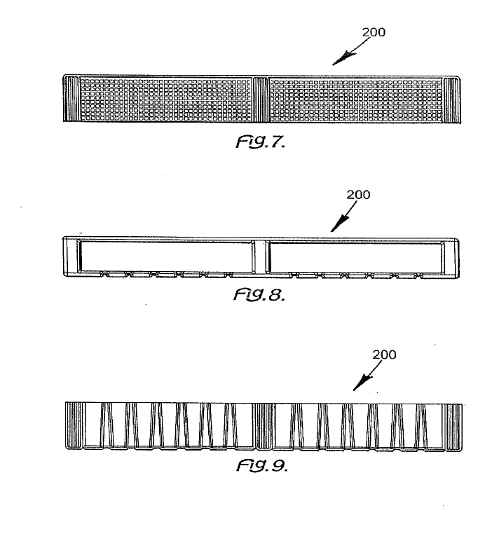

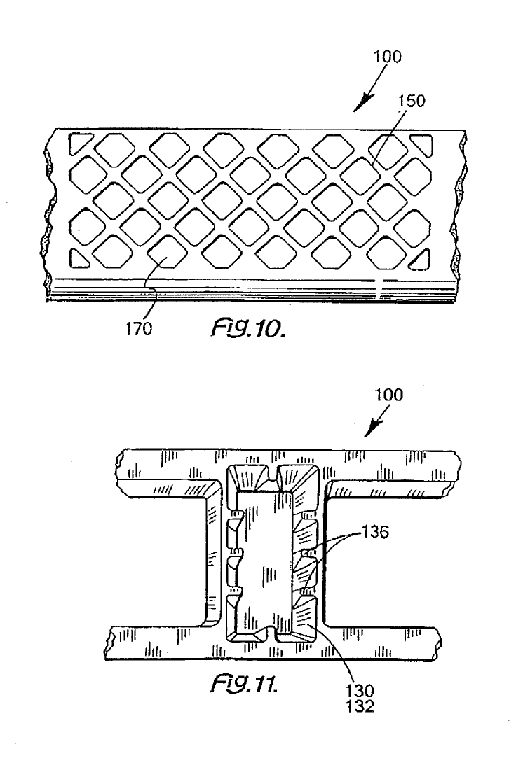

Turning now to FIG. 7, FIG. 8, and FIG. 9, three runner pallet support 200 adapted to receive first support board 118 and second support board 119, which are usually two inches by four inches. However, only first interior slot 130 is present, because only first center board 108 is present in the pallet 102 (FIG. 1 and FIG. 2). Thus, second interior slot 132 and second center board 110 are removed from this embodiment.

Adding FIG. 10 to the consideration, raised ribs 150 in either a square or a hexagonal pattern form honeycomb pattern 170, which provides support for the pallet support 100 on open side 120. Gripping ribs 126 (FIG. 4) and interior ribs 136 (FIG. 4) also add to the strength of the pallet support 100, as well as improving the grip of pallet support 100 on pallet 102. This structure also provides for a reduction in material use for the pallet support 100, while retaining the strength thereof.

Adding FIG. 11 to the consideration, the structure of first interior slot 130 and second interior slot 132 can be clearly seen. First interior slot 130 and second interior slot 132 have interior ribs 136 which improve the grip of pallet support 100 on pallet 102.

With the consideration of FIG. 12, reconfigurations of pallet 102 can be considered. When such reconfigurations occur, appropriate adjustments in the pallet support 100 can also be made. If only first center board 108 is present without second center board 110, first center board 108 is more centrally located between first support board 118 and second support board 119, which are on other side thereof. By that same token, end top board 114 and end bottom board 116 or back end top board 115 and back end bottom board 117 may be left in place if open side 120 is a little wider. In the same manner first closed end slot 122 and second closed end slot 124 can be adjusted.

However, first center board 108 and second center board 110 with end top board 114 and end bottom board 116 removed give the best results. The pallet support 100 is most useful such a structure for pallet 102.

Closed side 140 for pallet support 100 includes tong openings 142 for the tongs 144 of a forklift 146 or other lifting device. In this fashion, as pallet support 100 is applied to pallet 102, pallet 102 can still be lifted or used in its standard fashion, but with the pallet 102 having pallet support 100 thereon with much greater durability.

In the following examples, which are illustrate without unduly limiting the invention, all parts and percentages are by weight, unless otherwise specified.

### EXAMPLE 1

A polyurethane foam is prepared by blending the following. Composite materials being petrochemical based have two large disadvantages. First, this is a limited resource whose growing consumption negatively affects almost all aspects of our lives. Second, the increasing cost of petro-based composite materials diminishes the commercialization of composites into new products and prevents customers from realizing the benefits of composite materials. Composite manufacturing utilizing agricultural input materials reduce the relative content of petrochemicals and reduce the cost of the base material while promoting renewable sources.

In two structural tests, the bio-composite pallet performance is equivalent to the baseline composite pallet. The tests consist of loading the pallet in a test machine to represent a concentrated load and measuring the deflection of the pallet. The first test represented the load on a pallet while on the forks of a lift. The bio-composite pallet deflected the same amount as the baseline composite pallet: The second test represented a load on the pallet while the pallet is on the storage rack. The bio-composite pallet performed slightly better than the baseline pallet since it had less deflection.

Forklift Load-DeflectionTesting is based upon ASTM D1185 “Standard Test Methods for Pallets and Related Structures Employed in Materials Handling & Shipping”. The base of the pallet was supported on beams spaced 27″ apart to simulate forks from a lift.

A compressive load is applied down the center of the pallet on a plate parallel to the supports at 0.5 inches per minute. The load is applied also along the edges of the pallet deck parallel to the simulated forks. Test results are below.

Rack Load-Deflection

Testing is based upon ASTM D1185 “Standard Test Methods for Pallets and Related Structures Employed in Materials Handling & Shipping”. The pallet is placed on rack beam simulators. Two parallel line loads are centered on the test pallets. The line loads are spaced at a distance equal to half the width of the pallet. A compressive force is applied at a constant rate of 0.5 inches per minute. Test results are below.

### EXAMPLE 2

### Top to Bottom Compression

Testing is based upon ASTM D642 “Standard Test Method for Determining Compressive Resistance of Shipping Containers, Components, and Unit Loads”. Pallets and Related Structures Employed in Materials Handling & Shipping”.

Boards are placed on the pallet deck to uniformly distribute the load. A compressive force is applied at a constant rate of 0.5 inches per minute until 20 force capacity static load of 7,000 pounds was reached. There is no noticeable difference between the baseline and bio-composite pallet.

### EXAMPLE 2

### Compression Strength of Legs

Testing is based upon ASTM D1185 Standard Test Methods for Pallets and Related Structures Employed in Materials Handling & Shipping”. The pallet is placed on rack beam simulators. Two parallel line loads are centered on the test pallets. The line loads are spaced at a distance equal to half the width of the pallet. A compressive force is applied at a constant rate of 0.5 inches/minute. The procedure is performed on the center, middle, and corner leg on the edge of the pallet. There is no noticeable difference between the baseline and bio-composite pallet.

### EXAMPLE 3

### Impact

The pallet is kept at temperature range of plus or minus degree of minus 15 degrees Fahrenheit for a period of 56 hours. The pallet is:

A. Flat dropped on bottom from 8 feet.

B. Flat dropped on top from 8 feet.

C. Dropped on both sides (48″ and 40″) from 10 feet.

D. Dropped on one corner twice, from 10 feet, and then 15 feet.

No failure is noted. Failure is defined as any change in the geometry of the pallet that prevents normal operation, truck handling, stacking, or structural damage exceeding 1.5 inches squared.

### EXAMPLE 4

The procedure of Example 1 is repeated, but for the fibers being removed from the resin. When the pallet is tested with the modified pallet support, the pallet fails the tests.

This application—taken as a whole with the abstract, specification, claims, and drawings—provides sufficient information for a person having ordinary skill in the art to practice the invention disclosed and claimed herein. Any measures necessary to practice this invention are well within the skill of a person having ordinary skill in this art after that person has made a careful study of this disclosure.

Because of this disclosure and solely because of this disclosure, modification of this tool can become clear to a person having ordinary skill in this particular art. Such modifications are clearly covered by this disclosure.

1. A pallet support, the pallet support comprising:
an exterior frame, the exterior frame having an open side and a closed side;
the open side of the exterior frame having one or more slots;
the closed side of the exterior frame having one or more tong openings; and
wherein the open side of the pallet support receives a pallet.

2. A pallet support, the pallet support comprising:
an exterior frame, the exterior frame having an open side and a closed side;
the open side of the exterior frame having at least two slots that correspond with at least two stringers of a pallet;
the closed side of the exterior frame having one or more tong openings; and
wherein the at least two slots receive at least two stringers of the a pallet; and
wherein the closed side of the pallet encapsulates a side of the pallet when placed on the pallet.

3. The pallet support shield of claim 2, wherein the pallet is comprised of a composite material.

4. The pallet support shield of claim 3, wherein the composite material is a fiber reinforced polymer.

5. The pallet support shield of claim 2, wherein one or more gripping ribs are located within the at least two slots.

6. The pallet support shield of claim 5, wherein the one or more gripping ribs have a square shape.

7. The pallet support shield of claim 5, wherein the one or more gripping ribs have a hexagonal shape.

8. The pallet support shield of claim 2, wherein the pallet support shield is compression molded.

9. A method for reinforcing a pallet with a pallet support, the method comprising:
providing a pallet;
removing a top board and a bottom board from at least one end of the pallet, thereby exposing ends of at least two stringers of the pallet;
providing a pallet support shield, the pallet support shield comprising:
an exterior frame, the exterior frame having an open side and a closed side;
the open side of the exterior frame having at least two slots that correspond with at least two stringers of the pallet; and
the closed side of the exterior frame having one or more tong openings; and
placing said exposed ends of said at least two stringers of the pallet in said at least two slots; and
wherein the closed side of the pallet encapsulates at least one of the exposed ends of said stringers of the pallet when placed on the pallet; and
placing the pallet support shield on the at least two exposed stringers of the pallet.

10. The method of claim 9, wherein the pallet is comprised of a composite material.

11. The method of claim 10, wherein the composite material is a fiber reinforced polymer.

12. The method of claim 9, wherein one or more gripping ribs are located within the at least two slots.

13. The method of claim 12, wherein the one or more gripping ribs have a square shape.

14. The method of claim 12, wherein the one or more gripping ribs have a hexagonal shape.

15. The pallet support shield of claim 9, wherein the pallet support shield is compression molded.
